(19) United States
(12) Patent Application Publication
(10) Pub. No.: US 2018/0283529 A1
(43) Pub. Date: Oct. 4, 2018

(54) IMPACT SHIELDED OIL PAN

(71) Applicant: Allison Transmission, Inc., Indianapolis, IN (US)

(72) Inventor: Jezrah E. Horen, Fairland, IN (US)

(21) Appl. No.: 15/474,932

(22) Filed: Mar. 30, 2017

(51) Int. Cl. F16H 57/04

(52) U.S. Cl. CPC F16H 57/0452

(57) ABSTRACT

A protective shield configured to protect an oil pan from impact. The oil pan is illustratively formed of a polymer, and the protective shield is illustratively formed of an elastomer. A coupler illustratively secures the protective shield to the oil pan.

### FIELD OF THE DISCLOSURE

The present disclosure relates generally to an oil pan for use with a transmission and, more particularly, to an impact shielded polymer oil pan for use with a transmission.

### BACKGROUND OF THE DISCLOSURE

Fluid reservoirs for use in vehicles are often exposed to harsh environmental conditions. For example, transmission oil pans are typically supported by a transmission at a lower portion of the vehicle where the oil pan body is vulnerable to impact from rocks and other debris. Protection from impact is particularly important with oil pans formed of a polymer which typically have less impact resistance than conventional stamped metal oil pans. Prior attempts to protect polymer oil pans have focused on material selection, external impact features (e.g., ribs) and/or complex pan geometry, often resulting in increased costs. A challenge with conventional polymer oil pans is balancing the desire for low exposure (to minimize impact likelihood) with the need for a set volume of oil (i.e., oil turn rate requirement), yet protecting vulnerable areas of the oil pan.

### SUMMARY OF THE DISCLOSURE

The present disclosure provides a fluid reservoir for vehicle, illustratively a transmission oil pan, including simplified material selection to reduce material cost. An illustrative oil pan of the present disclosure may also eliminate external impact features (e.g., ribs) to reduce cost, material, and weight. An illustrative oil pan of the present disclosure may use easily moldable surfaces, thereby requiring less complex tooling and/or inspection. In an illustrative embodiment, vulnerable areas of the oil pan are shielded with a shock absorbing layer or shield (e.g., formed of an elastomer). The protective shield is illustratively secured in place with any combination of one or more different types of couplers. The illustrative oil pan assembly permits the use of cost effective materials for structural requirements of the oil pan, while including a selectable, removable, and replaceable protective shield for added impact resistance.

According to an illustrative embodiment of the present disclosure, an oil pan assembly for coupling to a lower portion of a vehicle includes an oil pan having a first side wall, a second side wall laterally spaced from the first side wall, a front end wall extending between the first side wall and a second side wall, and a rear end wall longitudinally spaced from the front end wall and extending between the first side wall and the second side wall. The first side wall, the second side wall, the front end wall, the rear end wall and the bottom wall define an exterior surface and an interior surface. An oil receiving chamber is defined by the interior surface. A protective shield is supported by the oil pan and is positioned adjacent to a protected portion of the exterior surface of the oil pan. The protective shield provides an impact resistance of at least 20 Newton meters (N−m) to the protected portion of the oil pan.

According to a further illustrative embodiment of the present disclosure, an oil pan assembly for coupling to a lower portion of a vehicle includes an oil pan having a first side wall, a second side wall laterally spaced from the first side wall, a front end wall extending between the first side wall and the second side wall, a rear end wall longitudinally spaced from the front end wall and extending between the first side wall and the second side wall, and a bottom wall extending between the first side wall and the second side wall and between the front end wall and the rear end wall. The first side wall, the second side wall, the front end wall, the rear end wall and the bottom wall define an exterior surface and an interior surface. An oil receiving chamber is defined by the interior surface, wherein the oil pan is formed of a polymer. A protective shield is supported by the oil pan and is positioned adjacent to at least a portion of the exterior surface of the oil pan, wherein the protective shield is formed of an elastomer.

According to another illustrative embodiment of the present disclosure, an oil pan assembly for coupling to a lower portion of the vehicle includes an oil pan having an exterior surface, an interior surface, and an oil receiving chamber defined by the interior surface. A protective shield is positioned adjacent to at least a portion of the exterior surface of the oil pan to define a protected portion of the oil pan. A coupler secures the protective shield to the oil pan.

According to a further illustrative embodiment of the present disclosure, an oil pan assembly for coupling to a lower portion of the vehicle includes an oil pan having an exterior surface, an interior surface, and an oil receiving chamber defined by the interior surface. A protective shield is positioned adjacent to at least a portion of the exterior surface of the oil pan. A scaffolding is positioned intermediate the oil pan of the protective shield. A first coupler secures the scaffolding to the oil pan. A second coupler secures the protective shield to the scaffolding.

According to another illustrative embodiment of the present disclosure, an oil pan assembly for coupling to a lower portion of the vehicle includes an oil pan having an exterior surface, an interior surface, and an oil receiving chamber defined by the interior surface. A protective shield is supported by the oil pan. The exterior surface of the oil pan includes a plurality vertically extending recesses, and the inner surface of the protective shield includes a plurality of vertically extending ribs. The ribs of the protective shield are received within the recesses of the oil pan to reduce lateral movement of the protective shield relative to the oil pan.

According to a further illustrative embodiment of the present disclosure, an oil pan assembly for coupling to a lower portion of the vehicle includes an oil pan having a body defining an exterior surface and an opposing interior surface. An oil receiving chamber is defined by the interior surface, and a mounting flange is supported by the body. A protective shield is supported by the mounting flange of the oil pan and is positioned adjacent to the exterior surface of the body. The protective shield is formed of an elastomer and includes a gasket portion extending above the mounting flange to provide an upper mounting seal.

According to another illustrative embodiment of the present disclosure, an oil pan assembly for coupling to a lower portion of the vehicle includes an oil pan having a first side wall, a second side wall laterally spaced from the first side wall, a front end wall extending between the first side wall and the second wall, a rear end wall longitudinally spaced from the front end wall and extending between the first side wall and the second side wall, and a bottom extending between the first side wall and the second side wall, and between the front end wall and the rear end wall. The first side wall, the second side wall, the front end wall, the rear end wall and the bottom wall define an exterior surface and an interior surface. An oil receiving chamber is defined by the interior surface. A protective shield is supported by the oil pan and is positioned adjacent only a portion of the exterior surface of the oil pan.

According to yet another illustrative embodiment of the present disclosure, an oil pan assembly for coupling to a lower portion of the vehicle includes an oil pan having a first side wall, a second side wall laterally spaced from the first side wall, a front end wall extending between the first side wall and a second side wall, and a rear end wall longitudinally spaced from the front end wall and extending between the first side wall and the second side wall, and a bottom wall extending between the first side wall and the second side wall and between the front end wall and the rear end wall. The first side wall, the second side wall, the front end wall, the rear end wall and the bottom wall define an exterior surface and an interior surface. An oil receiving chamber is defined by the interior surface. The front end wall has a first height, and the rear end wall has a second height, the first height being greater than the second height. The bottom wall slopes downwardly from the rear end wall toward the front end wall. A protective shield is supported by the oil pan as positioned adjacent to at least a portion of the exterior surface of the oil pan.

According to a further illustrative embodiment of the present disclosure, an oil pan assembly for coupling to a lower portion of the vehicle includes an oil pan having a first side wall, a second side wall laterally spaced from the first side wall, a front end wall extended between the first side wall and the second side wall, a rear end wall longitudinally spaced from the front end wall and extending between the first side wall and a second side wall, and a bottom wall extending between the first side wall and the second side wall and between the front end wall and the rear end wall. The first side wall, the second side wall, the front end wall, the rear end wall, and the bottom wall define an exterior surface and an interior surface. An oil receiving chamber is defined by the interior surface. The oil pan has an impact resistance of below 10 Newton meters (N−m). A protective shield is supported by the oil pan and positioned adjacent to a protected portion of the exterior surface of the oil pan. The protective shield provides an impact resistance of at least 20 Newton meters (N−m) to the protected portion of the oil pan.

According to yet another illustrative embodiment of the present disclosure, a protective shield for protecting an oil pan from impact includes an elastomeric body configured to be supported by an oil pan and positioned adjacent to a protected portion of the exterior surface of the oil pan. The protective shield provides an impact resistance of at least 20 Newton meters (N−m) to the protected portion of the oil pan. A coupler is configured to couple the elastomeric body to the oil pan.

### BRIEF DESCRIPTION OF THE DRAWINGS

The above-mentioned and other features and advantages of this disclosure, and the manner of attaining them, will become more apparent and will be better understood by reference to the following description of exemplary embodiments taken in conjunction with the accompanying drawings, wherein:

FIG. 1 is an exploded perspective view of an illustrative oil pan and impact shield of the present disclosure;

FIG. 2 is a cross-sectional view taken along line 2-2 of FIG. 1;

FIG. 3 is a cross-sectional view taken along line 3-3 of FIG. 1;

FIG. 4 is a cross-sectional view of a further illustrative embodiment impact shield of the present disclosure taken along line 2-2 of FIG. 1;

FIG. 5 is an exploded perspective view of a further illustrative oil pan and impact shield of the present disclosure;

FIG. 6 is a detailed perspective view, in partial cross-section, of an illustrative coupling device including a retaining clip;

FIG. 7 is a cross-sectional view of the illustrative coupling device of FIG. 6;

FIG. 8 is a detailed perspective view, in partial cross-section, of an illustrative coupling device including a barbed connector;

FIG. 9 is a cross-sectional view of the illustrative coupling device of FIG. 8;

FIG. 10 is a detailed perspective view, in partial cross-section, of an illustrative coupling device including bolts;

FIG. 11 is a cross-sectional view of the illustrative coupling device of FIG. 10;

FIG. 12 is a detailed perspective view, in partial cross-section, of the illustrative coupling device of FIG. 10, where the impact shield includes a gasket portion;

FIG. 13 is a cross-sectional view of the illustrative coupling device of FIG. 12;

FIG. 14 is a detailed perspective view of an illustrative impact shield including ribs engaging slots within an oil pan;

FIG. 15 is a cross-sectional view of the illustrative impact shield and oil pan of FIG. 14;

FIG. 16 is a detailed perspective view of an illustrative impact shield engaging the oil pan of FIG. 14;

FIG. 17 is a cross-sectional view of the illustrative impact shield and oil pan of FIG. 16;

FIG. 18 is a cross-sectional view similar to FIG. 17, showing a further illustrative impact shield and oil pan;

FIG. 19 is a cross-sectional view similar to FIG. 14, showing a further illustrative impact shield and oil pan including coupling magnets;

FIG. 20 is a cross-sectional view of the illustrative impact shield and oil pan of FIG. 19;

FIG. 21 is an exploded perspective view illustrating a scaffolding for coupling the protective shield to the oil pan;

FIG. 22 is a detailed perspective view of the scaffolding, the protective shield and the oil pan of FIG. 21; and

FIG. 23 is a cross-sectional view of the scaffolding, the protective shield and the oil pan of FIG. 22.

Corresponding reference characters indicate corresponding parts throughout the several views. The exemplification set out herein illustrates an exemplary embodiment of the invention and such exemplification is not construed as limiting the scope of the invention in any manner.

### DETAILED DESCRIPTION OF THE DISCLOSURE

For the purposes of promoting an understanding of the principles of the present disclosure, reference is now made to the embodiments illustrated in the drawings, which are described below. The embodiments disclosed below are not intended to be exhaustive or limit the present disclosure to the precise form disclosed in the following detailed description. Rather, the embodiments are chosen and described so that others skilled in the art may utilize their teachings. Therefore, no limitation of the scope of the present disclosure is thereby intended. Corresponding reference characters indicate corresponding parts throughout the several views.

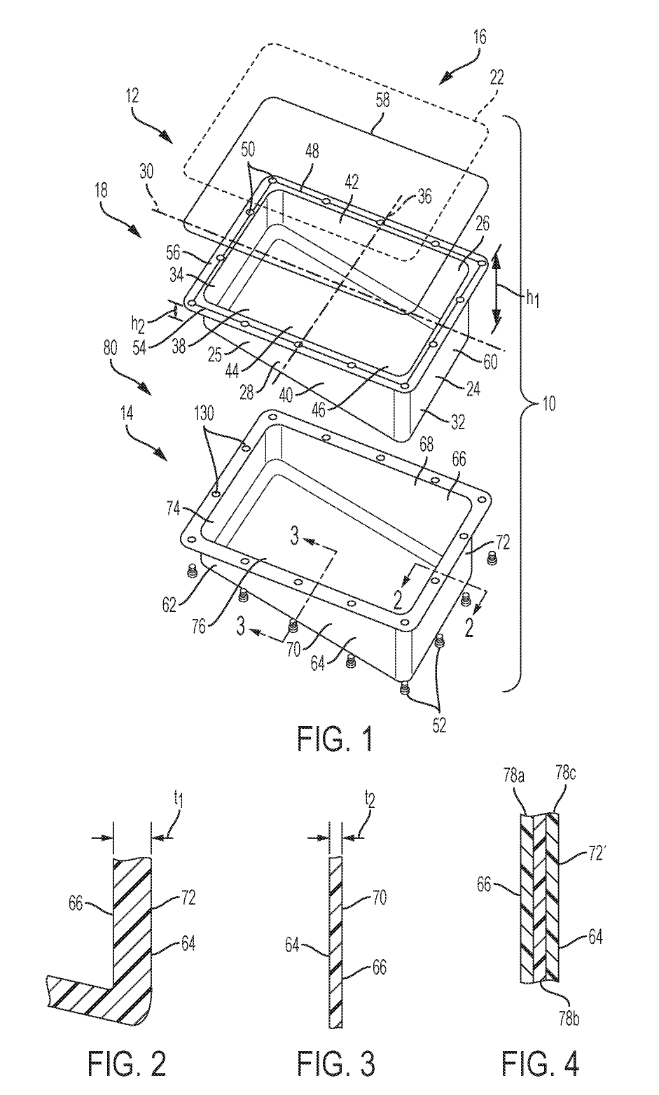

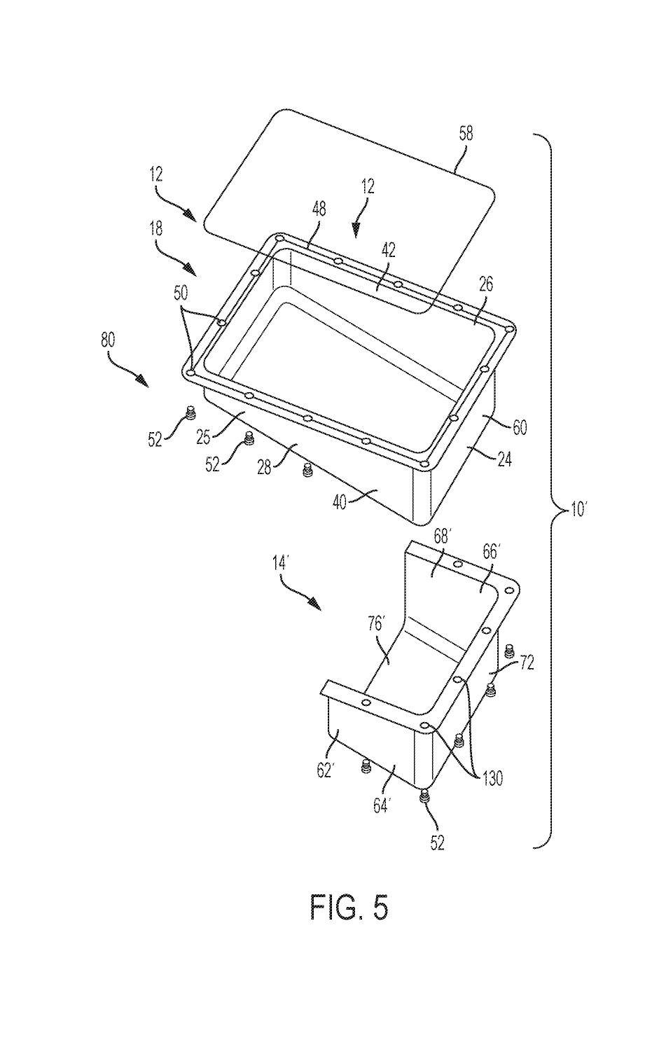

Referring initially to FIGS. 1 and 5, an illustrative oil pan assembly 10 is shown as including a conventional fluid reservoir 12 and an impact or protective shield 14 coupled to the fluid reservoir 12. The fluid reservoir 12 is shown for mounting to a lower portion of a vehicle 16. Illustratively, the fluid reservoir 12 may be an oil pan 18 for use with a transmission housing 22. Alternatively, the oil pan 18 may be for use with an internal combustion engine. The fluid reservoir 12 could also be of the type configured to receive other fluids, such as a gas tank, an engine coolant tank, a power steering reservoir, etc.

Illustratively, the oil pan 18 is mounted to the lower portion of a transmission housing 22 to supply transmission fluid or oil to lubricate gears inside the transmission housing 22 and reduce friction and wear on the gears. The oil pan 18 illustratively includes an oil pan body 24 formed of a polymer. The illustrative polymer is selected for strength, durability, chemical resistance, and corrosion resistance. Alternatively, the oil pan body 24 may be formed of other materials, such as stamped metal (e.g., galvanized steel or aluminum). Illustratively, the oil pan body 24 may be molded from a polyamide having nylon fibers. In one illustrative embodiment, the oil pan body 24 may be molded from a 30% glass filled nylon type 6/6.

The oil pan body 24 illustratively includes an outer wall 25 having a first side wall 26 and a second side wall 28 laterally spaced from the first side wall 26. Illustratively, the first side wall 26 and the second side wall 28 extend parallel to a longitudinal axis 30. The outer wall 25 of the oil pan body 24 further includes a front end wall 32 extending between the first side wall 26 and the second side wall 28. Similarly, the outer wall 25 includes a rear end wall 34 longitudinally spaced from the front end wall 32 and extends between the first side wall 26 and the second side wall 28. Illustratively, the front end wall 32 and the rear end wall 34 extend parallel to a lateral axis 36. A bottom wall 38 extends between the first side wall 26 and the second side wall 28, and between the front end wall 32 and the rear end wall 34.

The first side wall 26, the second side wall 28, the front end wall 32, the rear end wall 34 and the bottom wall 38 define an exterior surface 40 and an interior surface 42. An oil receiving chamber 44 is defined by the interior surface 42. In the illustrative embodiment, the front end wall 32 has a first height (h₁), and the rear end wall 34 has a second height (h₂), with the first height (h₁) being greater than the second height (h₂). As such, the bottom wall 38 slopes downwardly from the rear end wall 34 toward the front end wall 32, such that a sump 46 is defined by the oil receiving chamber 44 at the front end of the oil pan 18.

An outer rail or mounting flange 48 is illustratively supported by an upper end of the oil pan body 24. More particularly, the illustrative mounting flange 48 is supported by an upper end of the first side wall 26, the second side wall 28, the front end wall 32, and the rear end wall 34. As such, the mounting flange 48 extends around the periphery of the outer wall 25.

A plurality of openings 50 are formed within the mounting flange 48 to receive bolts 52 for securing the oil pan 18 to the transmission housing 22. A sealing groove 54 may be formed in the upper surface 56 of the mounting flange 48 to receive a gasket 58. The gasket 58 is configured to provide a fluid seal between the oil pan 18 and the transmission housing 22. In certain illustrative embodiments, a filter may be integrated within the oil pan body 24.

The protective shield 14 is supported by the oil pan 18 and is positioned adjacent to a protected portion 60 of the exterior surface 40 of the oil pan 18. The protective shield 14 may cover all or only a portion of the exterior surface 40 of the oil pan 18. The portion of the exterior surface 40 covered by the protective shield 14 is defined as the protected portion 60 of the oil pan 18.

Illustratively, the protective shield 14 is formed of an impact absorbing material, such as a resilient material and, more particularly, an elastomer. The elastomer may include synthetic rubber (e.g., a polymer with viscoelasticity) and/or natural rubber (e.g., vulcanized rubber). In certain illustrative embodiments, the protective shield 14 may be formed of a fluoroelastomer, such as Viton®, available from the Chemours Company of Wilmington, Del. In certain illustrative embodiments, the protective shield 14 may have a hardness of between 30 durometer and 90 durometer. In one illustrative embodiment, the protective shield 14 has a hardness of approximately 90 durometer.

With reference to FIGS. 1-5, the protective shield 14 illustratively includes a body 62 defining an outer surface 64 and an inner surface 66. The inner surface 66 faces and conforms to at least a portion of the exterior surface 40 of the oil pan 18. In the illustrative embodiments, the inner surface 66 is defined by a first side wall 68, a second side wall 70, a front end wall 72, a rear end wall 74, and a bottom wall 76. The second side wall 70 is laterally spaced from the first side wall 68. The front end wall 72 extends between the first side wall 68 and the second side wall 70. In the illustrative embodiment of FIG. 1, the rear end wall 74 is longitudinally spaced from the front end wall 72 and extends between the first side wall 68 and the second side wall 70. The bottom wall 76 extends between the first side wall 68 and the second side wall 70, and rearwardly from the front end wall 72. In the illustrative embodiment of FIG. 1, the bottom wall 76 extends between the front end wall 72 and the rear end wall 74.

The protective shield 14 may be tailored to protect the most vulnerable areas of the oil pan 18 from impact. As such, the protective shield 14 may cover only a portion of the oil pan 18 (i.e., the protected portion 60). For example, the protective shield 14 could be positioned adjacent to only the front end wall 32, or adjacent to only the bottom wall 38. In other illustrative embodiments, the protective shield 14 could be positioned adjacent to both the front end wall 32 and the bottom wall 38. As shown in the illustrative embodiment of FIG. 5, the protective shield 14 may not cover the entire exterior surface 40 of the oil pan body 24 and, as such, does not include rear end wall 74 (which overlaps the rear end wall 34 of the oil pan 18 in FIG. 1).

Illustratively, the unprotected oil pan 18 (i.e., without the protective shield 14) has an impact resistance of less than about 10 Newton meters N−m). In other words, the energy that can be absorbed by impact on the unprotected oil pan 18 is less than about 10 N−m. More particularly, the impact resistance of the unprotected oil pan 18 formed of a polyamide with nylon fibers is about 5 Newton meters (N−m). The impact resistance of the unprotected oil pan 18 formed of a 30% glass filled nylon type 6/6 is about 10 Newton meters (N−m). The impact resistance of the oil pan 18 is illustratively determined via conventional testing methods.

One such method is Izod impact testing where an impactor (e.g. a pivoting arm) is raised to a predetermined height and then released such that it impacts the oil pan 18 under test. In the illustrative testing method, the oil pan 18 is tested in all critical or impact prone areas or elements. An engineering analysis, such as a finite element analysis (FEA) dynamic simulation, of the oil pan 18 and the impactor may be performed to determine the weakest area of the oil pan 18. The angle at which the impactor is configured to strike the element of the oil pan 18 depends on the location of the element on the oil pan 18. Elements that face the direction of primary vehicle motion, such as the front end wall 32 of the oil pan 18, are configured to be impacted in a direction collinear to the direction of primary vehicle travel. Elements on the sides or bottom of the oil pan 18 are configured to be impacted at the worst case of either collinear to the direction of primary vehicle motion or limited to 45 degrees normal to the direction of primary vehicle travel. Each new element for evaluation is tested on a new oil pan 18.

In order to calculate the energy of impact, a reference height of the impactor is established. The actual mass or weight of the impactor, including hanger, is measured. Energy is calculated by the formula: Energy (n−m)=mass (kg)*32.2 (m/s²)*Δheight (m), where Δ height is the difference between the reference height at the point of impact and the measurement of the height at the point of impactor release. The oil pan 18 is considered to pass if the exterior surface 40 or the interior surface 42 of the oil pan body 24 does not crack or if a hole is not present. Cosmetic damage to the body 24 that is not predicted to cause fluid leakage, such as scratches and dents, are considered to be acceptable.

The protective shield 14 illustratively provides an impact resistance of at least 20 Newton meters (N−m) to the protected portion 60 of the oil pan 18. In one illustrative embodiment, the protective shield 14 provides an impact resistance of about 30 Newton meters (N−m) to the protected portion 60 of the oil pan 18. The impact resistance of the protected portion 60 of the oil pan 18 may be evaluated by testing the combined oil pan 18 and protective shield 14 (i.e., oil pan assembly 10), using conventional methods, such as Izod impact testing in the manner detailed above.

In other illustrative embodiments, the protective shield 14 may have portions or areas of different thicknesses. More particularly, the areas of the protective shield 14 more likely to experience substantial impact may be thicker than those areas less likely to experience such impact. For example, the thickness (t₁) of the front end wall 72 and/or the bottom wall 76 may be greater than the thickness (t₂) of the side walls 68 and 70. In an illustrative embodiment, the thickness (t₁) of the front end wall 72 and/or the bottom wall 76 is approximately 0.25 inches (6.35 millimeters), while the thickness (t₂) of the side walls 68 and 70 is approximately 0.125 inches (3.18 millimeters).

In yet other illustrative embodiments, the protective shield 14 may have different portions or areas with different material compositions. For example, material hardness in different areas of the protective shield 14 may vary based upon predicted impact. In other illustrative embodiments, different areas of the protective shield 14 may include elastomers with different temperature ratings for use as a heat shield. Alternatively, a thin layer of sheet metal (e.g., steel or aluminum) may define a heat shield.

With reference to FIG. 4, a plurality of adjacent layers 78 extend between the outer surface 64 and the inner surface 66 of the protective shield 14. Each of the layers 78 illustratively includes a different material composition. For example, first or inside layer 78a may be formed of a relatively high temperature rating material (e.g., an elastomer or sheet metal), second or middle layer 78b may be formed of an impact absorbing material (e.g., an elastomer such as Viton), and a third or outer layer 78c may be formed of a relatively high temperature rating material (e.g., an elastomer or sheet metal).

In certain illustrative embodiments, deflectors (e.g., ribs) may be formed within the outer surface 64 and/or the inner surface 66 of the protective shield 14 to assist in dissipating impact energy. In one illustrative embodiment, the deflectors may comprise a waffle pattern extending outwardly from the outer surface 64 and/or the inner surface 66.

A coupling device or coupler 80 illustratively secures the body 62 of the protective shield 14 to the body 24 of the oil pan 18. In certain illustrative embodiments, the coupler 80 secures the protective shield 14 to the mounting flange 48 of the oil pan 18. In other illustrative embodiments, the coupler 80 secures the protective shield 14 to the oil pan 18 independent of the mounting flange 48. In one illustrative embodiment, a plurality of couplers 80 are used to secure the protective shield 14 relative to the oil pan 18. The number, location and type of couplers 80 may vary based upon geometry, material selection and anticipated environmental conditions (e.g., impact).

In certain illustrative embodiments, the coupler 80 is a friction fit between the protective shield 14 and the oil pan 18. More particularly, tension within the elastomeric body 62 of the protective shield 14 facilitates frictional engagement between the inner surface 66 of the protective shield 14 and the exterior surface 40 of the oil pan 18. In other illustrative embodiments, the coupler 80 may include an adhesive between the inner surface 66 and the exterior surface 40 for securing the protective shield 14 to the oil pan 18.

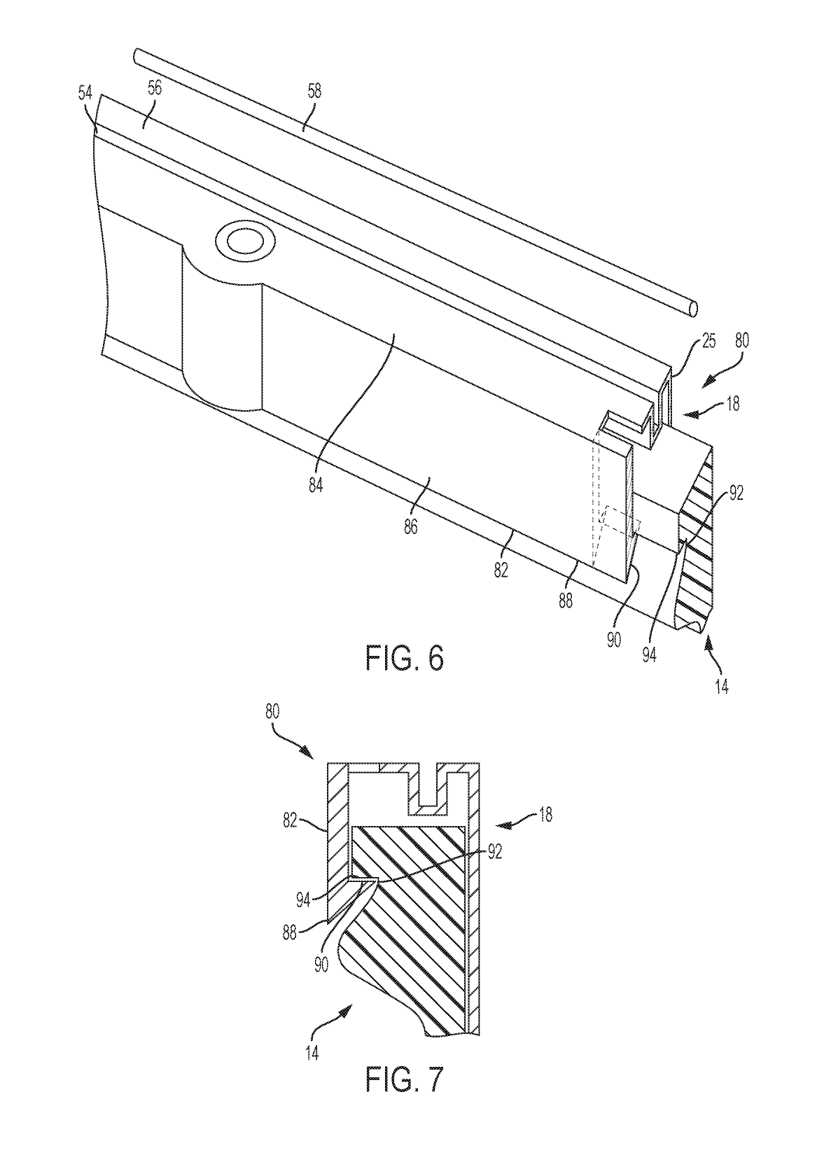

With reference to FIGS. 6 and 7, another illustrative coupler 80 includes a retaining clip 82 supported by the mounting flange 48 of the oil pan 18 and configured to secure the protective shield 14 to the oil pan 18. More particularly, the retaining clip 82 is positioned outwardly from the outer wall 25 of the oil pan 18 by a support wall 84. An arm 86 extends downwardly from the support wall 84 and includes a freely supported lower end 88 supporting a retention lip 90. The arm 86 is flexibly supported such that the retention lip 90 of the oil pan 18 may be received within a cooperating groove 92 defined by a retaining lip 94 of the protective shield 14.

In various illustrative embodiments, the retaining clip 82 may be supported by one or more of the front end wall 32, the first side wall 26, the second side wall 28, and the rear end wall 34 of the oil pan 18. Similarly, the cooperating groove 92 and retaining lip 94 may be supported by one or more of the front end wall 72, the first side wall 68, the second side wall 70, and the rear end wall 74 of the protective shield 14.

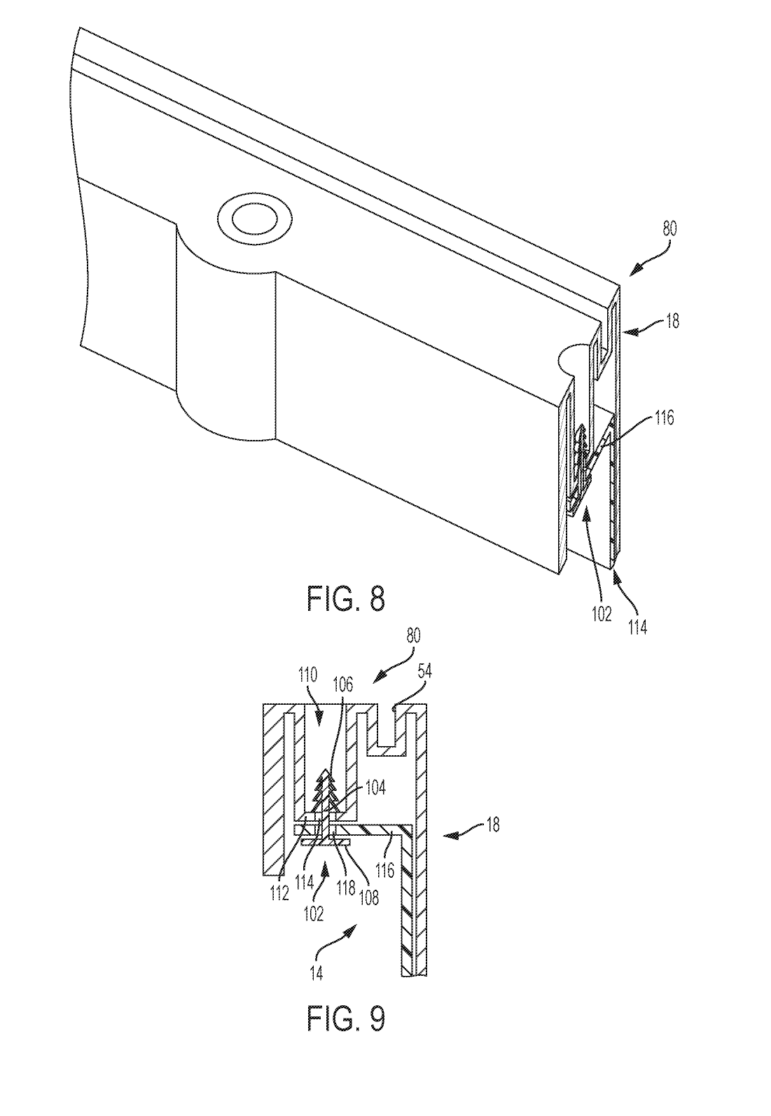

With reference to FIGS. 8 and 9, a further illustrative coupler 80 includes a barbed connector 102 configured to secure the protective shield 14 to the mounting flange 48 of the oil pan 18. More particularly, the barbed connector 102 includes a shaft 104 supporting a plurality of barbs 106 at a distal end and a head 108 at the proximal end. A retaining chamber 110 is supported by the mounting flange 48 of the oil pan 18 and includes a lower wall 112 including mounting openings 114. The protective shield 14 includes a mounting flange 116 including mounting openings 118. The barbed connector 102 extends through aligned openings 114 and 116.

In other illustrative embodiments, the barbed connector 102 can be integrally molded with one of the protective shield 14 and/or the oil pan 18. In other illustrative embodiments, different types of couplers may be formed integral with the protective shield 14 and/or the oil pan 18.

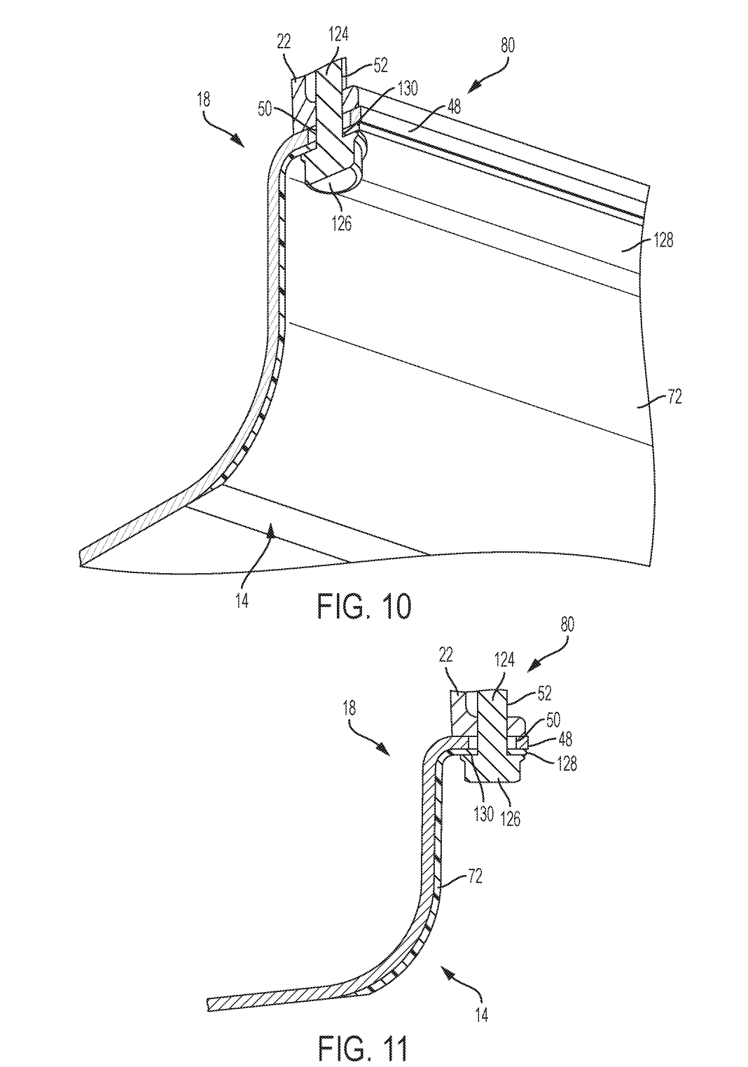

With reference to FIGS. 10 and 11, an illustrative coupler 80 includes bolts 52 configured to secure the protective shield 14 to the mounting flange 48 of the oil pan 18. More particularly, the bolt 52 includes a distal threaded shaft 124 and a proximal head 126. The protective shield 14 includes a mounting flange 128 including mounting openings 130. The bolts 52 extend through openings 130 of the protective shield 14 and openings 50 of the oil pan 18. Illustratively, the threaded shaft 124 is threadably received within the transmission housing 22 such that the mounting flange 128 of the protective shield 14 is retained by the head 126 of the bolt 52.

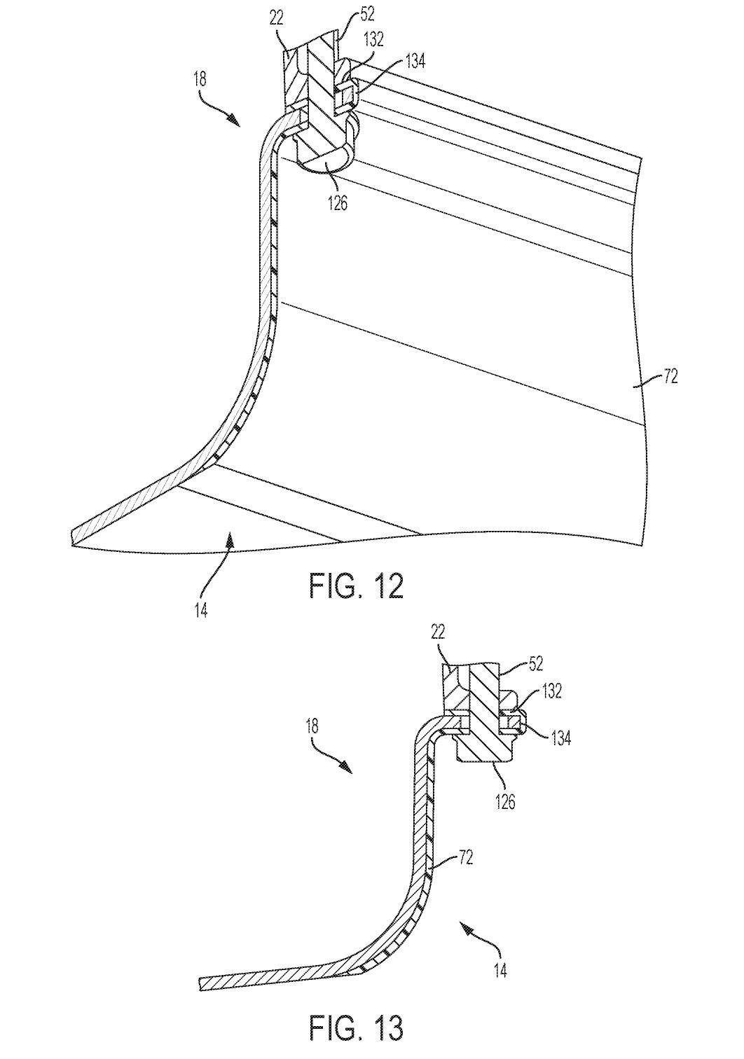

FIGS. 12 and 13 illustrate a variation of the protective shield 14 shown in FIGS. 10 and 11. Protective shield 14 includes a gasket portion 132 defining an upper seal for the mounting flange 48. More particularly, the mounting flange 128 wraps around an outer edge 134 of the mounting flange 48. Illustratively, the threaded shaft 124 of bolt 52 is threadably received within the transmission housing 22 such that the mounting flange 128 of the protective shield 14 is retained by the head 126 of the bolt 52 and the gasket portion 132 defines a fluid seal between the oil pan 18 and the transmission housing 22.

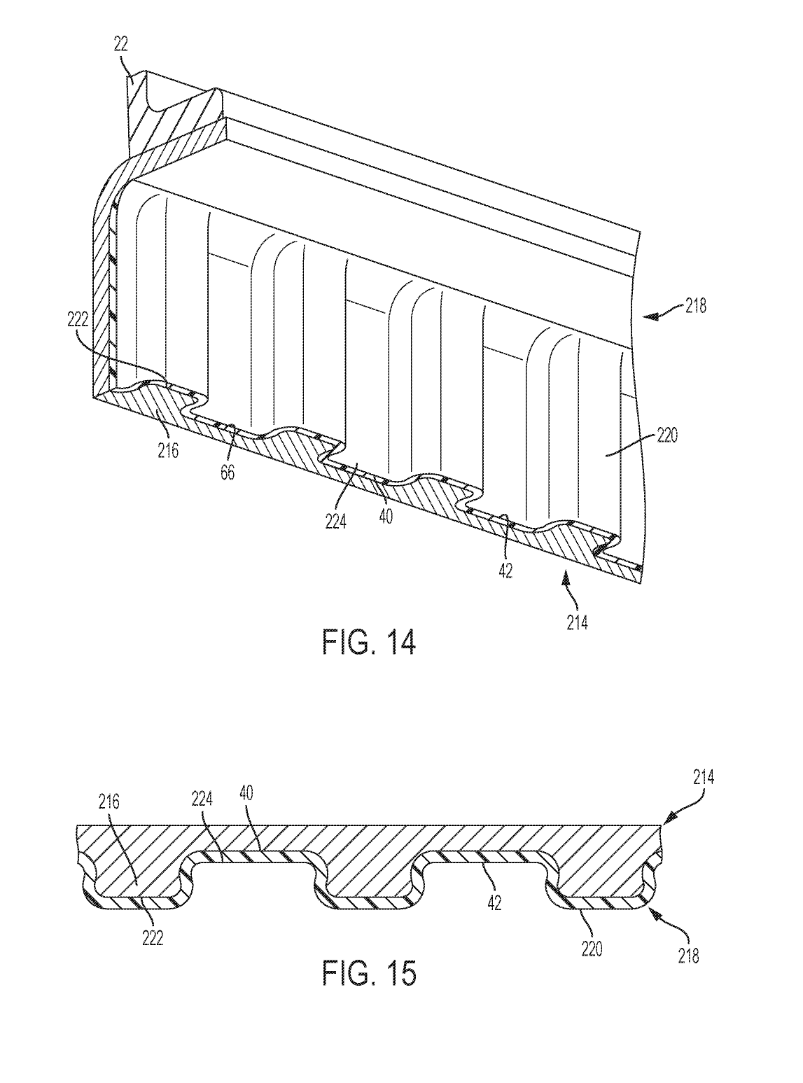

FIGS. 14 and 15 show an illustrative protective shield 214 including a plurality of laterally spaced, vertically extending ribs 216. The protective shield 214 is substantially similar to the protective shield 14 detailed above. The ribs 216 extend inwardly from the inner surface 66 of the protective shield 214. An oil pan 218 includes a plurality of vertically extending flutes 220 formed within the outer wall 25. The oil pan 218 is substantially similar to the oil pan 18 detailed above. The flutes 220 define a plurality of laterally spaced, vertically extending slots 222 in the exterior surface 40 of the oil pan 218, and a plurality of laterally spaced, vertically extending slots 224 in the interior surface 42 of the oil pan 218. The ribs 216 are received within the slots 222 to assist in securing the protective shield 214 to the oil pan 218. More particularly, engagement between the ribs 216 and the slots 222 prevent lateral movement of the protective shield 214 relative to the oil pan 218.

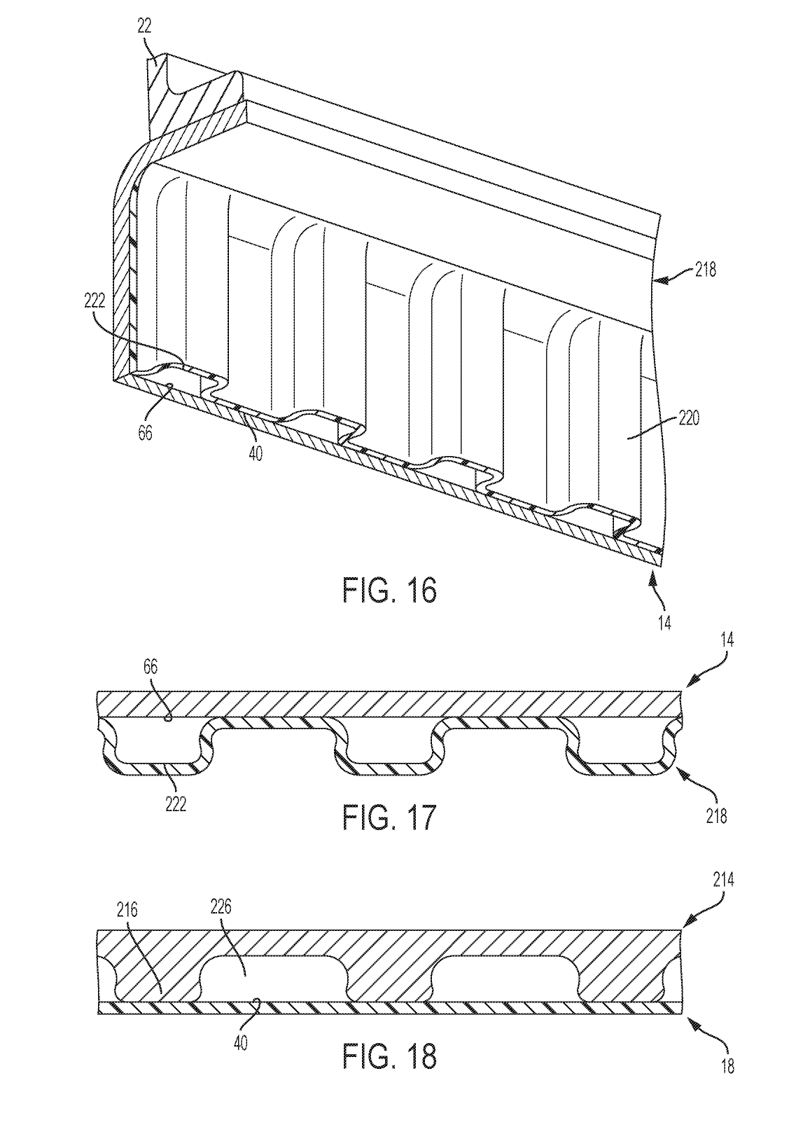

FIGS. 16 and 17 show illustrative protective shield 14 of FIG. 1 engaging the illustrative oil pan 218 of FIG. 14. More particularly, the planar inner surface 66 of the protective shield 14 engages the exterior surface 40 of the oil pan 218.

FIG. 18 shows illustrative protective shield 214 of FIGS. 14 and 15 engaging the oil pan 18 of FIG. 1. The ribs 216 define standoffs between the protective shield 214 and the oil pan 18, such that air gaps 226 are defined between laterally adjacent ribs 216. The air gaps 226 are configured to absorb impact energy. The protective shield 214 may be formed of a greater hardness (i.e., higher durometer) to prevent cuts, since the air gaps absorb energy.

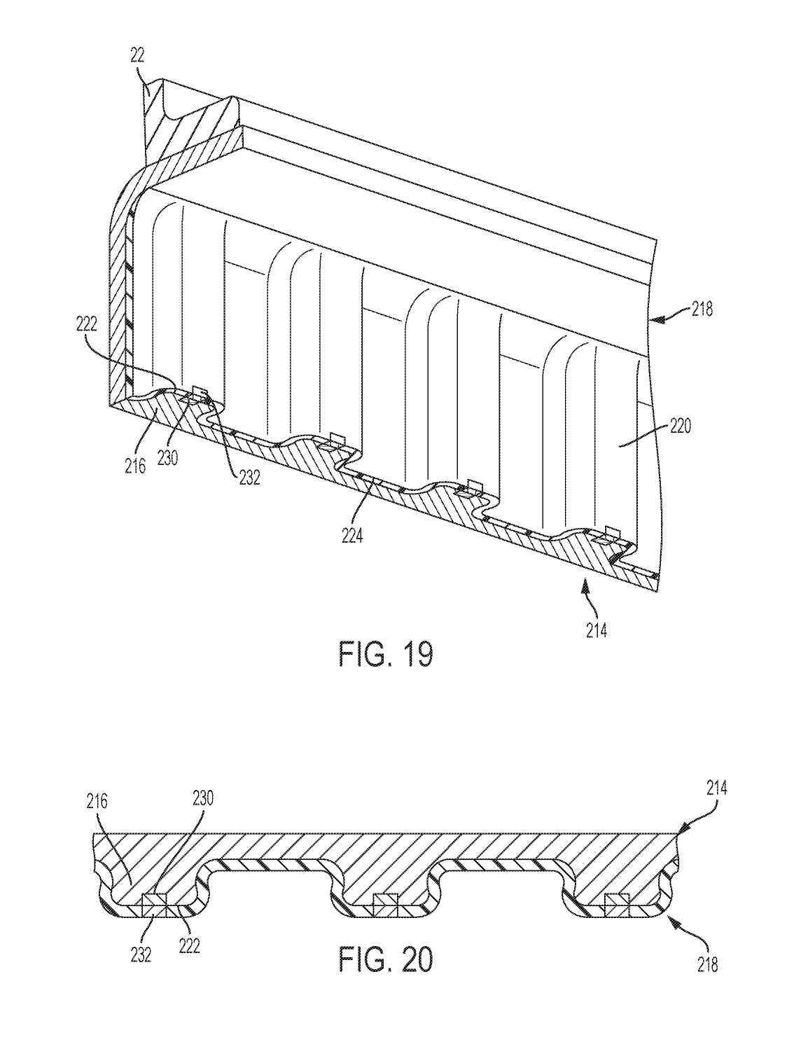

FIGS. 19 and 20 show protective shield and oil pan of FIGS. 14 and 15 but with magnets 230, 232 supported by at least one of the protective shield 214 and the oil pan 218. In certain illustrative embodiments, magnets 230 in the protective shield 214 are magnetically attracted to magnets and/or magnetically attractive elements 232 in the oil pan 218 to secure the protective shield 214 to the oil pan 218. In other illustrative embodiments, magnets 232 in the oil pan 218 are magnetically attracted to magnets and/or magnetically attractive elements 230 in the protective shield 214 to secure the protective shield 214 to the oil pan 218. The magnets 230, 232 may be secured to the protective shield 214 and the oil pan 218 in any conventional manner, such as adhesives, fasteners, and/or overmolding.

In other illustrative embodiments, magnets 230, 232 may be located in the bottom wall of the oil pan 218, illustratively within the sump, to collect metal shavings.

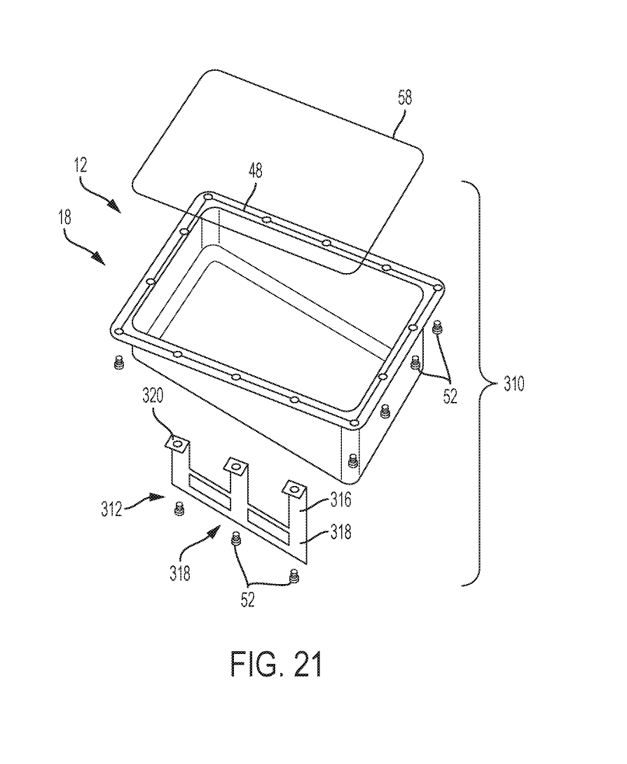

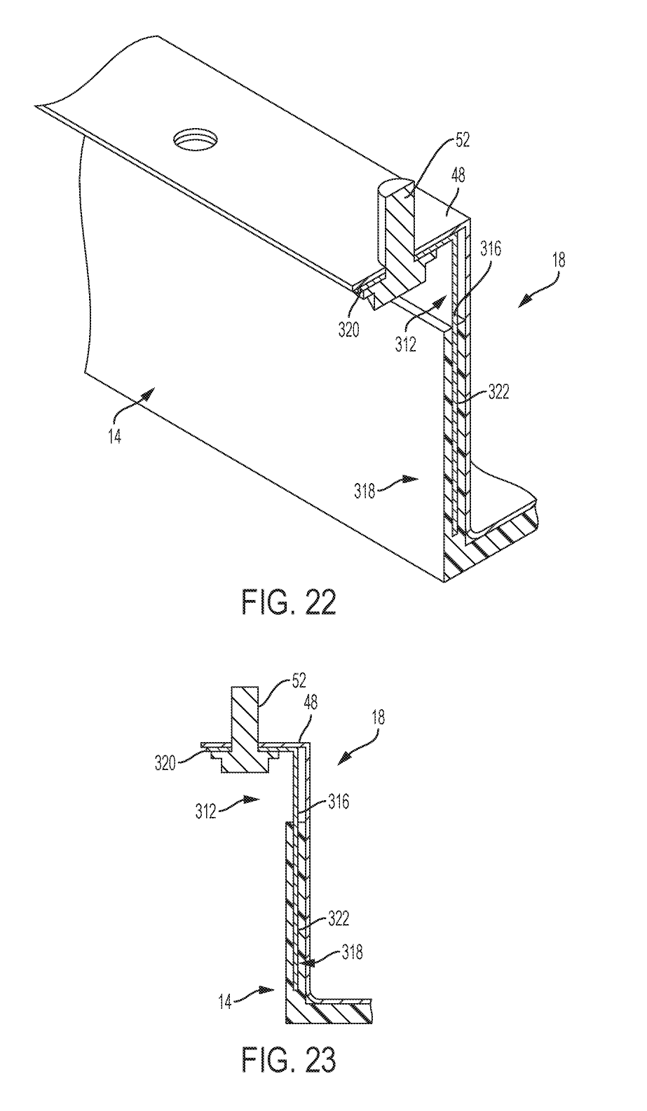

FIGS. 21-23 show an illustrative oil pan assembly 310 including many of the same elements as oil pan assembly 10 as detailed above. Oil pan assembly 310 includes an intermediate coupler, illustratively a scaffolding 312 for coupling the protective shield 14 to the oil pan 18. Illustratively, the scaffolding 312 includes a plurality of legs 316 supporting a coupler 318 to secure to the protective shield 14. An upper portion of each leg 316 includes a mount 320 to be secured to the mounting flange 48.

The coupler 318 illustratively includes a groove 322 within the shield 14 for frictionally engaging the scaffolding 312. In other illustrative embodiments, different couplers may be substituted for coupler 318. For example, the retaining clip 82, the barbed connector 102 and/or the bolts 52, as further detailed herein, may be used to secure the protective shield 14 to the scaffolding 312, and/or to secure the scaffolding 312 to the oil pan 18.

The scaffolding 312 may be formed of any suitable material, such as a molded polymer or a stamped metal. Additionally, the scaffolding 312 may be a single component or formed of multiple elements.

The illustrative oil pan assembly of the present disclosure provides an oil pan that may be formed of relatively inexpensive polymers with simple geometries. The illustrative protective shield may be easily replaceable and customizable, thereby allowing for different protection levels with reduced tooling requirements. Additionally, a single illustrative oil pan assembly can have multiple areas of different impact resistance (e.g., areas of the protective shield with different thicknesses, material compositions and/or layers).

While this invention has been described as having exemplary designs, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1. An oil pan assembly for coupling to a lower portion of a vehicle, the oil pan assembly comprising:
an oil pan including a first side wall, a second side wall laterally spaced from the first side wall, a front end wall extending between the first side wall and the second side wall, a rear end wall longitudinally spaced from the front end wall and extending between the first side wall and the second side wall, and a bottom wall extending between the first side wall and the second side wall and between the front end wall and the rear end wall;
wherein the first side wall, the second side wall, the front end wall, the rear end wall, and the bottom wall define an exterior surface and an interior surface, and an oil receiving chamber is defined by the interior surface; and
a protective shield supported by the oil pan and positioned adjacent to a protected portion of the exterior surface of the oil pan, the protective shield providing an impact resistance of at least 20 Newton meters (N−m) to the protected portion of the oil pan.

2.-5. (canceled)

6. The oil pan assembly of claim 1, wherein the protective shield includes an inner surface and an outer surface, the inner surface facing the exterior surface of the oil pan, and a plurality of adjacent layers extending between the inner surface and the outer surface, each of the layers having a different material composition.

7. The oil pan assembly of claim 1, wherein the protective shield includes a first portion having a first thickness, and a second portion having a second thickness, the first thickness greater than the second thickness.

8. The oil pan assembly of claim 7, wherein the first portion of the protective shield is positioned adjacent to the front end wall of the oil pan, and the second portion of the protective shield is positioned adjacent to at least one of the first side wall, the second side wall, the rear end wall and the bottom wall of the oil pan.

9. The oil pan assembly of claim 1, further comprising a coupler configured to couple the protective shield to the oil pan.

10. The Oil pan assembly of claim 9, wherein the oil pan includes a mounting flange supported by at least one of the first side wall, the second side wall, the front end wall, and the rear end wall, and the coupler is configured to couple the protective shield to the mounting flange.

11. The oil pan assembly of claim 10, further comprising a scaffolding positioned intermediate the oil pan and the protective shield.

12. The oil pan assembly of claim 1, wherein the exterior surface of the oil pan includes a plurality of vertically extending recesses, and the inner surface of the protective shield includes a plurality of vertically extending ribs, the ribs received within the recesses to reduce lateral movement of the protective shield relative to the oil pan.

13. The oil pan assembly of claim 1, wherein the oil pan includes a mounting flange supported by at least one of the first side wall, the second side wall, the front end wall, and the rear end wall, and the protective shield includes a gasket portion extending above the mounting flange to provide an upper mounting seal.

14. The oil pan assembly of claim 1, wherein the protective shield is positioned adjacent only a portion of the exterior surface of the oil pan.

15. The oil pan assembly of claim 1, wherein the protective shield provides an impact resistance of at least 30 Newton meters (N−m) to the protected portion of the oil pan.

16. (canceled)

17. The oil pan assembly of claim 1, further comprising magnets supported by the protective shield.

18. (canceled)

19. An oil pan assembly for coupling to a lower portion of a vehicle, the oil pan assembly comprising:
an oil pan including a first side wall, a second side wall laterally spaced from the first side wall, a front end wall extending between the first side wall and the second side wall, a rear end wall longitudinally spaced from the front end wall and extending between the first side wall and the second side wall, and a bottom wall extending between the first side wall and the second side wall and between the front end wall and the rear end wall;
wherein the first side wall, the second side wall, the front end wall, the rear end wall and the bottom wall define an exterior surface and an interior surface, and an oil receiving chamber is defined by the interior surface, the oil pan being formed of a polymer; and
a protective shield supported by the oil pan and positioned adjacent to a protected portion of the exterior surface of the oil pan, wherein the protective shield is formed of an elastomer.

20. The oil pan assembly of claim 19, wherein the protective shield provides an impact resistance of at least 20 Newton meters (N−m) to the protected portion of the oil pan.

21.-22. (canceled)

23. The oil pan assembly of claim 19, wherein the protective shield includes an inner surface and an outer surface, the inner surface facing the exterior surface of the oil pan, and a plurality of adjacent layers extending between the inner surface and the outer surface, each of the layers having a different material composition.

24. The oil pan assembly of claim 19, wherein the protective shield includes a first portion having a first thickness, and a second portion having a second thickness, the first thickness greater than the second thickness.

25. The oil pan assembly of claim 24, wherein the first portion of the protective shield is positioned adjacent to the front end wall of the oil pan, and the second portion of the protective shield is positioned adjacent to at least one of the first side wall, the second side wall, the rear end wall and the bottom wall of the oil pan.

26. An oil pan assembly for coupling to a lower portion of a vehicle, the oil pan assembly comprising:
an oil pan including an exterior surface, an interior surface, and an oil receiving chamber defined by the interior surface;
a protective shield positioned adjacent to at least a portion of the exterior surface of the oil pan to define a protected portion of the oil pan; and
a coupler securing the protective shield to the oil pan.

27. The oil pan assembly of claim 26, wherein the protective shield provides the protected portion of the oil pan with an impact resistance of at least 20 Newton meters (N−m).

28. The oil pan assembly of claim 26, wherein the oil pan includes:
a first side wall, a second side wall laterally spaced from the first side wall, a front end wall extending between the first side wall and the second side wall, a rear end wall longitudinally spaced from the front end wall and extending between the first side wall and the second side wall, and a bottom wall extending between the first side wall and the second side wall and between the front end wall and the rear end wall; and
a mounting flange supported by, and extending outwardly from, at least one of the first side wall, the second side wall, the front end wall, and the rear end wall, and the coupler is configured to couple the protective shield to the mounting flange.

29. The oil pan assembly of claim 28, further comprising a scaffolding positioned intermediate the mounting flange and the protective shield.

30. The oil pan assembly of claim 28, wherein the coupler includes a retention clip configured to engage a lip on the protective shield.

31. The oil pan assembly of claim 28, wherein the coupler includes a barbed fastener extending through openings in the protective shield and the mounting flange.

32. The oil pan assembly of claim 28, wherein the coupler includes bolts extending through openings in the protective shield and the mounting flange.

33. (canceled)

34. The oil pan assembly of claim 32, wherein the protective shield includes a gasket portion extending above the mounting flange to provide an upper mounting seal.

35. (canceled)
